(19) United States
(12) Patent Application Publication
(10) Pub. No.: US 2014/0085759 A1
(43) Pub. Date: Mar. 27, 2014

(54) POWER SUPPLY CIRCUIT AND POLARITY REVERSAL PROTECTION CIRCUIT

(71) Applicant: Webasto SE, Stockdorf (DE)

(72) Inventor: Uwe Richter, Greifenberg (DE)

(21) Appl. No.: 14/119,612

(22) PCT Filed: May 7, 2012
(86) PCT No.: PCT/EP2012/058383

§ 371 Date: Nov. 22, 2013

(30) Foreign Application Priority Data
May 30, 2011 (DE) 10 2011 076 732.0

(51) Int. Cl. H02H 3/18; G05F 3/08

(52) U.S. Cl. CPC H02H 3/18; G05F 3/08
USPC 361/84; 323/311

(57) ABSTRACT

A power supply circuit for a voltage step-up circuit comprises a diode and a first controllable semiconductor, wherein the diode is connected in series to the first controllable semiconductor in a main current direction of the first controllable semiconductor. The diode electrically connects an output of the first controllable semiconductor to an output of the power supply circuit. A polarity reversal protection circuit for an electric load comprises an output stage, a voltage step-up circuit and a power supply circuit according to the invention.

The invention relates to a power supply circuit for a voltage step-up circuit, wherein the power supply circuit comprises a diode and a first controllable semiconductor, and the diode is connected in series to the first controllable semiconductor in a main current direction of the first controllable semiconductor.

The invention further relates to a polarity reversal protection circuit for an electric load, wherein the polarity reversal protection circuit comprises an output stage and a voltage step-up circuit.

The U.S. Pat. No. 6,611,410 B1 describes a polarity reversal protection circuit comprising an N-channel MOSFET. The MOSFET is connected in series to a load so that the (internal) body diode of the MOSFET is connected in the forward direction in the normal operation without reversed polarity and prevents a current flow through the load in case of a polarity reversal of the supply voltage terminals. To attain the minimum possible voltage drop between the drain and source of the MOSFET in the on-state the gate voltage potential has to be higher than a supply voltage potential of the polarity reversal protection circuit. The reverse polarity protection is achieved by a trigger circuit for the gate of the MOSFET only generating a gate voltage high enough to switch the MOSFET to the conducting state in the normal operation without reversed polarity. The trigger circuit is supplied with electric power from an inverter circuit using the inductivities of a direct current motor and phase switches.

If no inductivities can be used for this purpose the voltage for the trigger circuit has to be generated in another way. The DE 196 55 180 C2 describes polarity reversal protection circuits comprising a voltage doubler circuit (realised as a charge pump) which are respectively used to generate gate voltage for a power MOSFET. To turn the voltage doubler circuit on or off an electronic switch is provided which is also embodied by a MOSFET.

The DE 198 45 673 A1 describes a circuit in which a charge pump is protected against a polarity reversal of the voltage supply by means of a bridge circuit.

It is an object of the present invention to provide a power supply circuit which is more energy-efficient than conventional power supply circuits and/or more cost-efficient in its production than conventional power supply circuits.

Further, it is an object of the present invention to provide a polarity reversal protection circuit for an electric load having this advantage.

This object is solved by the features of the independent claims. Advantageous embodiments of the invention are described in the dependent claims.

The invention is based on the conventional power supply circuit in that the diode electrically connects an output of the first controllable semiconductor to an output of the power supply circuit. In this way the power supply circuit can deactivate itself in case of a reversed polarity. Owing to the fact that here only the blocking capacity of a single diode is relevant a high reliability of the reverse polarity protection function can be attained. By a series connection of two diodes instead of the single diode the reliability of the polarity reversal protection circuit can be further increased in cases in which one of the two diodes becomes inoperative.

The power supply circuit may comprise a first electric or electronic component electrically connecting a voltage supply terminal of the power supply circuit to the output of the power supply circuit.

The first electric or electronic component may further comprise a first impedance. The first impedance renders a differential voltage to the first supply voltage terminal possible. With an electronic configuration of the first electric or electronic component ohmic losses in the power supply circuit can be minimised. To this end the power supply circuit may be configured as a push-pull output stage, for example as a complementary output stage or as a quasi-complementary output stage. Apart from this, a signal form and/or a frequency spectrum of the alternating voltage supplied to the voltage step-up circuit can be influenced by means of the first impedance if the first impedance comprises a reactance.

The first impedance may comprise a first resistor. A MOSFET has particularly good disabling properties in the back direction in the non-conducting state and particularly good conducting properties in the forward direction in the conducting state. However, it is also possible to use another type of field-effect transistor, a bipolar transistor, an IGBT or another type of controllable semiconductor switch instead of a MOSFET for the first controllable semiconductor.

The first controllable semiconductor may comprise a MOSFET, particularly an N-channel MOSFET.

The first controllable semiconductor may comprise a bipolar transistor, particularly an npn transistor.

The invention is based on the conventional polarity reversal protection circuit in that the polarity reversal protection circuit comprises a power supply circuit according to the invention. In this way it can be prevented that a voltage is applied to the control input of the output stage in case of a polarity reversal which might switch the output stage to the conducting state in case of a polarity reversal.

The polarity reversal protection circuit may comprise a second electric or electronic component electrically connecting a control input of the output stage to a voltage supply terminal of the output stage. With an electronic configuration of the second electric or electronic component ohmic losses in the output stage can be minimised by increasing its ohmic conducting-state DC resistance while it is not required for a voltage equalisation between the control input and the voltage supply terminal of the output stage. If the impedance comprises a reactive component it can be used to influence a signal form and/or a frequency spectrum of the alternating voltage supplied to the control input of the output stage.

The second electric or electronic component may comprise a second impedance.

The second impedance may comprise a second resistor.

The output stage may comprise a second controllable semiconductor.

A source electrode or a drain electrode of the second controllable semiconductor may be electrically connected to the voltage supply terminal of the polarity reversal protection circuit. In this way the voltage supply of the electric load may also be used for the power supply circuit.

A body diode of the second controllable semiconductor may be oriented in the forward direction in a normal operating mode of the output stage.

The second controllable semiconductor may comprise a MOSFET, particularly an N-channel MOSFET. A MOSFET has particularly good barrier properties in the back direction in the non-conducting state and particularly good conducting properties in the forward direction in the conducting state. However, it is also possible to use another type of field-effect transistor, a bipolar transistor, an IGBT or another type of controllable semiconductor switch instead of a MOSFET for the second controllable semiconductor.

The voltage step-up circuit may comprise a voltage doubler circuit and/or a Villard circuit and/or a Greinacher circuit and/or a Delon circuit. In this way a voltage increase can be achieved without inductivities. Inductivities are generally hard to realise in integrated circuits.

The invention will now be described by way of example with the aid of particularly preferred embodiments with reference to the accompanying drawings in which:

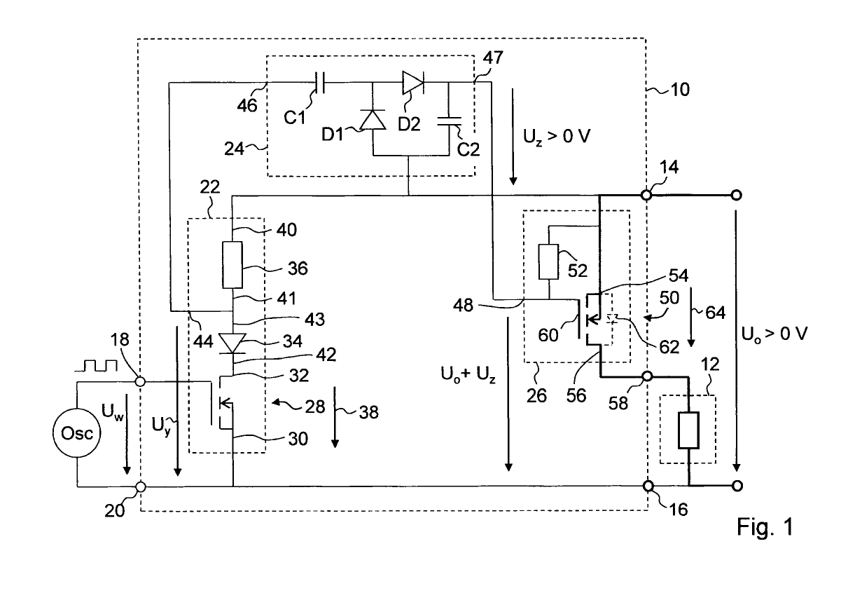

FIG. 1 shows a schematic block diagram of a polarity reversal protection circuit for an electric load.

First, the configuration of the embodiment of the polarity reversal protection circuit 10 shown in FIG. 1 will be described. The polarity reversal protection circuit 10 for the voltage supply of an electric load 12 may comprise a pair of terminals 14, 16 for a supply voltage Uₒ, a pair of terminals 18, 20 for an alternating voltage signal U_{w}, a power supply circuit 22, a voltage step-up circuit 24 and an output stage 26.

The power supply circuit 22 may comprise a first N-channel MOSFET 28 of the enhancement type the source electrode 30 of which is connected to the negative terminal 16 for the supply voltage Uₒ. The drain electrode 32 of the first MOSFET 28 may be connected to the positive terminal 14 for the supply voltage Uₒ via a series connection 34, 36. The series connection 34, 36 may comprise a diode 34 which is switched in the forward direction 38 in the normal operation (operation without reversed polarity), and a first resistor 36. A first terminal 40 of the first resistor 36 may be connected to the positive terminal 14 for the supply voltage Uₒ. A cathode 42 of the diode 34 may be connected to the drain electrode 32 of the first MOSFET 28. The other terminal 41 of the resistor 36 may be connected to an anode 43 of the diode 34 and may be an output 44 of the power supply circuit 22 provided and suitable for supplying an alternating voltage U_{y} to an input 46 of the voltage step-up circuit 24.

In the embodiment shown in FIG. 1 a Greinacher circuit known to persons skilled in the art is used as the voltage step-up circuit 24. Alternatively, any other type of voltage step-up circuit 24 comprising or not comprising inductivities can be used here. The output 47 of the voltage step-up circuit 24 may be connected to a control input 48 of the output stage 26. A gate capacitance of the second controllable semiconductor 50 may be partly or even exclusively used as the capacitance C2 of the Greinacher circuit.

The output stage 26 may comprise a second N-channel MOSFET 50 and a second resistor 52. A source electrode 54 of the second MOSFET 50 may be connected to a positive terminal 14 for the supply voltage Uₒ. A drain electrode 56 of the second MOSFET 50 may be connected to a controlled load output terminal 58 for connecting and operating an electric load 12. The load 12 may be connected and operated between the load output terminal 58 and the negative terminal 16 for the supply voltage Uₒ. The second resistor 52 may be connected between a gate 60 of the second MOSFET 50 and the positive terminal 14 for the supply voltage Uₒ.

The second MOSFET 50 may comprise a body diode 62. The body diode 62 may be switched for an operating mode without reversed polarity of the polarity reversal protection circuit 10 in the main forward direction 64 of the output stage 26. In the operating mode with reversed polarity, then, the body diode 62 is switched in the back direction.

Now, the functional principles of the embodiment of the polarity reversal protection circuit 10 will be explained. The polarity reversal protection circuit 10 may include two reverse polarity protection functions. The first reverse polarity protection function may protect the electric load 12 against a polarity reversal. The first reverse polarity protection function may consist in that the section between the drain terminal 56 and the source terminal 54 of the second MOSFET 50 is high-ohmic in case of a polarity reversal of the supply voltage Uₒ. This may, on the one hand, be achieved by the second MOSFET 50 being arranged in the circuit so that its body diode 62 is oriented in the back direction in case of a polarity reversal. From this it follows that the body diode 62 may oriented be in the forward direction 64 of the output stage 26 during a normal operation and without reversed polarity.

The output stage 26 therefore does not necessarily have to be provided for switching the electric load 12 on and off in the normal operation. On the other hand, the body diode 62 usually has only moderate on-state properties so that applications are well conceivable in which the difference between the conductance of the second MOSFET 50 in the through-connected and in the non-through-connected state is sufficient for a proper operation of the application despite of the body diode 62 being oriented in the forward direction 64. In these cases the second MOSFET 50 may not only serve as the reverse polarity protection, but also as a switching application.

For the electric load 12 to be protected against a polarity reversal the second MOSFET 50 may not switch to the conducting state in case of a polarity reversal of the supply voltage Uₒ. To accomplish this, a resistor 52 capable of effecting a voltage reduction between the gate electrode 60 and the source electrode 54 of the second MOSFET 50 may be arranged between the Gate-terminal 60 of the second MOSFET 50 and the first supply voltage terminal 14. To prevent a voltage U_{z} from building up between the gate electrode 60 and the source electrode 54 anyway the voltage supply of the gate terminal 60 has to be interrupted or disabled in case of a polarity reversal. This may be accomplished by preventing current from flowing through the power supply circuit 22 in case of a polarity reversal (and, particularly, also in case of an activation during a polarity reversal). To this end, the diode 34 may then be switched in back the direction. In this way the power supply circuit 22 cannot amplify the alternating voltage signal U_{w} supplied by an alternating voltage signal source Osc in case of a polarity reversal. The power supply circuit 22 can then no longer supply an alternating voltage U_{y} to the voltage step-up circuit 24. Consequently, the voltage step-up circuit 24 is also incapable of supplying an input voltage Uₒ+U_{z} high enough to switch the second MOSFET 50 to the conducting state to the control input 48 of the output stage 26. In case of an activation during a polarity reversal, the diode 34 particularly also prevents the gate 60 of the second controllable semiconductor 50 from being supplied with an activation impulse which would otherwise transmitted to the gate 60 via the first controllable semiconductor 28, the input capacitor C1 and the series diode D2 and the effect of which on the output stage 26 and/or the electric load 12 may be particularly detrimental in case of a polarity reversal.

With the suggested advantageous arrangement of a single current valve 34 in the power supply circuit 22 an effective reverse polarity protection may successfully be provided for which a smaller number of components is required as compared to conventional polarity reversal protection circuits.

The description, the claims and the drawing are intended to also disclose embodiments complementary to the explicitly described embodiments. For example, a negative supply voltage can be applied instead of a positive supply voltage Uₒ if a P-channel MOSFET is used instead of a N-channel MOSFET 28, 50 and the polarity of the output of the voltage step-up circuit 24 is reversed or a complementary voltage step-up circuit is used.

### LIST OF NUMERALS

10 polarity reversal protection circuit

12 electric load

14 positive terminal for supply voltage Uₒ

16 negative terminal for supply voltage Uₒ

18 first terminal for alternating voltage signal U_{w}

20 second terminal for alternating voltage signal U_{w}

22 power supply circuit

24 voltage step-up circuit

26 output stage

28 first controllable semiconductor; first MOSFET

30 source electrode of the first MOSFET 28

32 drain electrode of the first MOSFET 28

34 diode

36 first resistor

38 main forward direction of the first MOSFET 28

40 first terminal of the resistor 36

41 second terminal of the resistor 36

42 cathode of the diode 34

43 anode of the diode 34

44 output of the power supply circuit 22

46 input of the voltage step-up circuit 24

47 output of the voltage step-up circuit 24

48 control input of the output stage 26

50 second controllable semiconductor; second MOSFET

52 second resistor

54 source electrode of the second MOSFET 50

56 drain electrode of the second MOSFET 50

58 load output terminal of the output stage 26

60 gate of the second MOSFET 50

62 body diode

64 forward direction of the output stage 26

Osc oscillator

Uₒ supply voltage

U_{w} alternating voltage signal

U_{y} alternating voltage

U_{z} boost

C1 input capacitor of the Greinacher circuit 24

C2 smoothing capacitor of the Greinacher circuit 24

D1 clamping diode of the Greinacher circuit 24

D2 series diode of the Greinacher circuit 24

1. A power supply circuit for a voltage step-up circuit, wherein the power supply circuit comprises a diode and a first controllable semiconductor and the diode is connected in series to the first controllable semiconductor in a main current direction of the first controllable semiconductor, and wherein the diode electrically connects an output of the first controllable semiconductor to an output the power supply circuit.

2. The power supply circuit according to claim 1, wherein the power supply circuit comprises a first electric or electronic component electrically connecting a voltage supply terminal of the power supply circuit to the output of the power supply circuit.

3. The power supply circuit according to claim 2, wherein the first electric or electronic component comprises a first impedance.

4. The power supply circuit according to claim 3, wherein the first impedance comprises a first resistor.

5. The power supply circuit according to claim 1, wherein the first controllable semiconductor (28) comprises an N-channel MOSFET.

6. The power supply circuit according to claim 1, wherein the first controllable semiconductor comprises an npn biploar transistor.

7. A polarity reversal protection circuit for an electric load, wherein the polarity reversal protection circuit comprises an output stage and a voltage step-up circuit, having a power supply circuit according to claim 1.

8. The polarity reversal protection circuit according to claim 7, having a second electric or electronic component electrically connecting a control input of the output stage to a voltage supply terminal of the output stage.

9. The polarity reversal protection circuit according to claim 8, wherein the electric or electronic component has a second impedance.

10. The polarity reversal protection circuit according to claim 9, wherein at the second impedance is a second resistor.

11. The polarity reversal protection circuit according to claim 7, wherein the output stage comprises a second controllable semiconductor.

12. The polarity reversal protection circuit according to claim 11, wherein a source electrode or a drain electrode of the second controllable semiconductor is electrically connected to a voltage supply terminal of the polarity reversal protection circuit.

13. The polarity reversal protection circuit according to claim 11, wherein a body diode of the second controllable semiconductor is oriented in a forward direction in a normal operating mode of the output stage.

14. The polarity reversal protection circuit according to claim 11, wherein the second controllable semiconductor comprises a MOSFET, particularly an N-channel MOSFET.

15. The polarity reversal protection circuit according to claim 7, wherein the voltage step-up circuit comprises a voltage doubler circuit and/or a Villard circuit and/or a Greinacher circuit and/or a Delon circuit.
